(19) United States
(12) Patent Application Publication
(10) Pub. No.: US 2011/0126960 A1
(43) Pub. Date: Jun. 2, 2011

(54) APPARATUS AND METHOD FOR APPLYING LABELS TO CONTAINERS

(75) Inventors: Ireneo Orlandi, Curtatone (IT); Daniele Marastoni, San Giovanni in Persiceto (IT)

(73) Assignee: SACMI VERONA S.P.A., Imola, BO (IT)

(21) Appl. No.: 12/990,279

(22) PCT Filed: Apr. 27, 2009
(86) PCT No.: PCT/IB09/05377

§ 371 Date: Feb. 11, 2011

(30) Foreign Application Priority Data
Apr. 30, 2008 (IT) MO2008A000130

(51) Int. Cl. B32B 37/06

(52) U.S. Cl. 156/84; 156/382

(57) ABSTRACT

An apparatus for applying a “shrink sleeve” label to a container includes a casing member for enclosing a container in a closed chamber, a heating device for heating a heat-shrinkable element that is a precursor of a “shrink sleeve” label arranged around the container so as to heat-shrink the heat-shrinkable element, and a pressure-reducing member to reduce the pressure in the closed chamber.

Apparatus and method for applying labels to containers The invention relates to an apparatus and a method for applying to containers heat-shrinkable labels of the sleeve type that are commonly known as “shrink sleeve” labels. The labels applied with the apparatus and the method according to the invention can be made of polyethylene terephthalate (PET), polyvinyl chloride (PVC), polypropylene (PP), polystyrene (PS), or other materials that are suitable for being heat-shrunk.

An apparatus is known comprising a carousel suitable for supporting in a peripheral region thereof a plurality of bottles to which a label has to be applied. The apparatus comprises an applying device that applies to each bottle positioned on the carousel a tubular element made of heat-shrinkable film, which is the precursor of a “shrink sleeve” label. The tubular element, before being heat-shrunk, has a cross section that is greater than the cross section of the respective bottle, so as to be able to be easily splined on the latter. When the tubular element has been splined on the bottle, between the tubular element and the bottle a gap is defined.

After receiving the respective tubular elements, the bottles are conveyed along a heating tunnel into which water vapour is injected that is suitable for heating the tubular elements to cause the tubular elements to heat-shrink. In this manner labels are obtained that adhere stably to the relative bottles.

The heating tunnel has an inlet end, through which the bottles enter with the respective tubular elements, and an outlet end, through which the bottles are evacuated to which the labels adhere. Through the inlet end and the outlet end the heating tunnel communicates with the external environment.

A flow of water vapour touches the bottles and the tubular elements whilst the latter travel along the heating tunnel. The water vapour yields to each tubular element a quantity of heat that is necessary for the tubular element to be able to heat shrink. In this manner, the water vapour cools and tends to pass to the liquid stage, thus generating drops of condensate that wet the tubular element and the bottle. At the outlet from the heating tunnel, the bottles are packed into cardboard boxes for storage and/or dispatch. In order to heat-shrink the tubular element intended for forming the label, it is possible to use heating systems other than water vapour, for example infrared-ray heating systems or hot-air heating systems. Also in these cases drops of water can form on the container that are due to the phenomenon of condensation if, for example, the label is applied to a cold container, i.e. to a container that has been filled at low temperature.

The drops of water that form on the bottles and on the respective labels owing to the condensation of the steam may give rise to various undesired effects.

In particular, the drops of water may wet the cardboard boxes in which the bottles are packed so much as to damage the boxes.

Further, the water vapour that has infiltrated the gap between the bottle and the tubular element generates condensate that may remain trapped between the bottle and the label, once that the latter adheres to the bottle. Owing to the effect of the condensate trapped inside the label, protuberances or bubbles that are aesthetically unappealing may be generated on the latter. The risk that a certain quantity of condensate remains entrapped between the bottle and the latter is greater if the surface of the bottle is not regular and, for example, notches or grooves are obtained thereupon.

Lastly, if the labels are applied to empty containers, the condensate could be deposited inside the containers and remain there, encouraging the formation of moulds.

The quantity of condensate that is generated in the heat-shrinking process can be reduced if dry saturated steam is used or if the water vapour is overheated.

Nevertheless, after the condensation arising from heat-shrinking a certain fraction of water in liquid state remains, albeit in reduced quantity. Further, in order to overheat the water vapour a large quantity of heat is required, which entails a significant expenditure of energy. An object of the invention is to improve known apparatuses and methods for applying labels to containers.

Another object of the invention is to provide an apparatus and a method for applying labels to containers that is able to reduce drastically, or even eliminate, the presence of condensation at the end of the cycle of applying the label to the container.

In a first aspect of the invention, an apparatus is provided for applying a “shrink sleeve” label to a container, comprising casing means for enclosing said container in a closed chamber, heating means for heating a heat-shrinkable element that is the precursor of said “shrink sleeve” label arranged around said container so as to heat-shrink said heat-shrinkable element, characterised in that it further comprises pressure-reducing means to reduce the pressure in said closed chamber.

In a second aspect of the invention, a method is provided for labelling a container with a “shrink sleeve” label, comprising receiving said container in a closed chamber, heating a heat-shrinkable element that is the precursor of said “shrink sleeve” label for heat-shrinking said heat-shrinkable element around said container, characterised in that it further comprises reducing pressure in said closed chamber.

Owing to these aspects of the invention, it is possible to apply a label to a container without condensate remaining on the container at the end of the heat-shrinking process. In particular, reducing the pressure in the closed chamber enables the temperature to be lowered at which condensate is generated, so as to reduce significantly or even eliminate the drops of liquid found on the container. Further, it is no longer necessary to overheat the steam, which entails a significant reduction in the consumption of energy.

Owing to the method and to the apparatus according to the invention, the container and the “shrink sleeve” label, at the end of the process of applying the label, are substantially dry. This effectively prevents the risks of possible damage that the condensate may cause, for example, to cardboard boxes for packaging labelled containers.

It is further possible to prevent the formation of undesired bubbles or protuberances due to the condensate that remains trapped between the label and the container. Labelled containers of high aesthetic quality are thus obtained. Further, if the label is applied to an empty container, drops of water remaining inside the container is avoided.

The invention can be better understood and actuated with reference to the attached drawings, which illustrate some embodiments thereof by way of non-limiting example, in which:

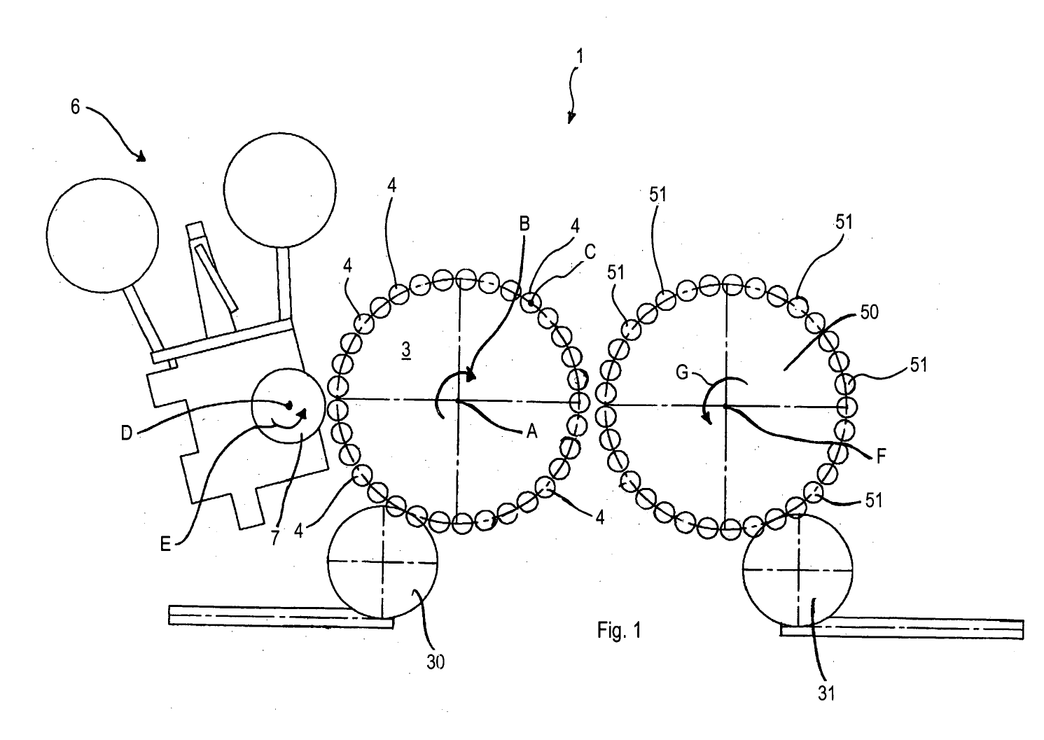

FIG. 1 is a schematic top view of an apparatus for applying labels to containers;

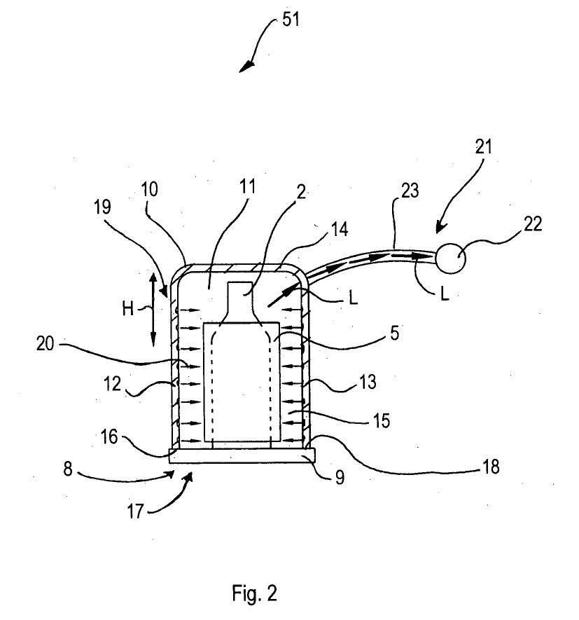

FIG. 2 is a partially sectioned view of a first embodiment of casing means of the apparatus in FIG. 1;

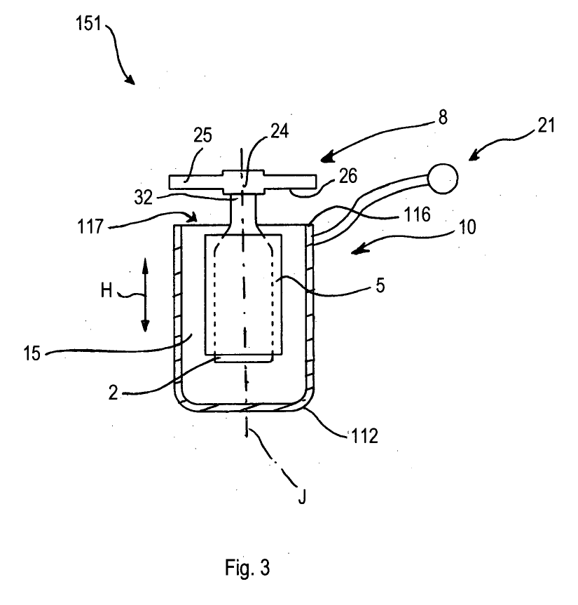

FIG. 3 is a partially sectioned view of a second embodiment of casing means of the apparatus in FIG. 1;

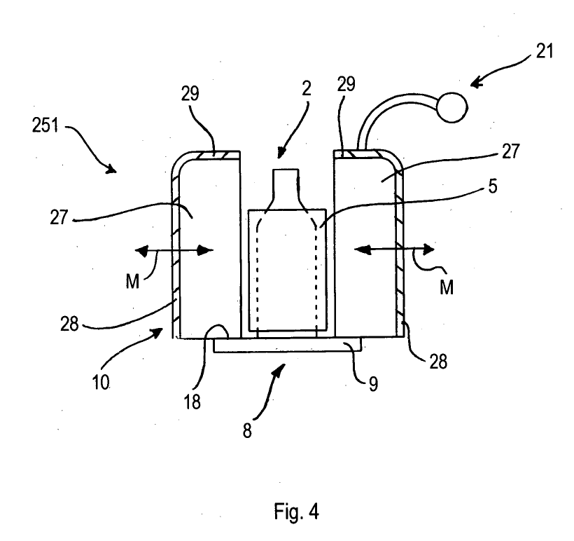

FIG. 4 is a partially sectioned view of a third embodiment of casing means of the apparatus in FIG. 1.

In FIG. 1 there is shown an apparatus 1 for applying labels to containers, such as, for example, bottles. The labels applied by the apparatus 1 are made of heat-shrinkable plastics and are shaped as tubular elements. These labels are normally named “shrink sleeve” labels. They can be obtained from a film of polyethyleneterephthalate (PET), polyvinyl chloride (PVC), polypropylene (PP), polystyrene (PS), or other materials that are suitable for being heat-shrunk.

The apparatus 1 comprises an inlet wheel 30 suitable for conveying to an applying carousel 3 the containers to which the labels have to be applied. The applying carousel 3 is suitable for applying, to each container, a tubular element that is the precursor of a label. The carousel 3 is rotatable around a rotation axis A, in a rotation direction B. In the illustrated example, the rotation axis A is substantially vertical.

Downstream of the applying carousel 3 a heat-shrinking carousel 50 is arranged in which the containers, to which the tubular elements were applied that were the precursors of the labels, are heated so as to cause the tubular elements to heat-shrink. In this manner, the tubular elements shrink and acquire the shape and the dimensions of the containers, to which they adhere stably.

A transferring device that is not shown can be interposed between the applying carousel 3 and the heat-shrinking carousel 50 to transfer the containers to which the tubular elements were applied by the applying carousel 3 to the heat-shrinking carousel 50. In one embodiment, the transferring device may comprise a transferring carousel. The apparatus 1 further comprises an outlet wheel 31 to remove from the heat-shrinking carousel 50 the containers to which the labels were applied.

An unwinding device 6 is further provided for unwinding a film of heat-shrinkable plastics intended for forming the labels from a reel on which the film is initially wound. The unwinding device 6 gives the film to a transferring drum 7. The transferring drum 7 has a side surface on which a plurality of openings is obtained. Through such openings air is sucked to maintain the film in contact with the transferring drum 7.

The transferring drum 7 is rotatable around a longitudinal axis D that can be parallel to the rotation axis A of the applying carousel 3. The transferring drum 7 rotates in a respective rotation axis E opposite the rotation axis B of the applying carousel 3. A cutting device that is not shown cuts the film that is wound on the transferring drum 7, such as to define discrete portions of film that are intended for generating the “shrink sleeve” labels.

The applying carousel 3 supports, in a peripheral region thereof, a plurality of operating units 4, each of which is suitable for applying a tubular element that is the precursor of a label on a corresponding bottle.

Each operating unit 4 comprises a supporting element for supporting a container to which a label has to be applied. Each operating unit 4 further comprises a spindle that is rotatable, according to the rotation axis B, around an axis C that may be parallel to the rotate axis A of the applying carousel 3. Each spindle has a side surface on which a plurality of openings is obtained through which air can be sucked or can be blown.

Each spindle is configured for receiving from the transferring drum 7 a respective portion of film, that can be maintained adhering to the spindle owing to the air aspirated through the openings of the corresponding side surface. Whilst the spindle rotates around the axis C, the portion of film coming from the transferring drum 7 is progressively wound on the spindle, until two opposite longitudinal flaps of the portion of film are superimposed one another. These flaps are fixed to one another, for example by gluing, heat welding, laser welding or other techniques by means of a fixing device that is not shown positioned along the path of the spindles.

A tubular element is thus generated that is the precursor of a “shrink sleeve” label.

By blowing air through the openings of the spindle the tubular element can be detached from the side surface of the spindle. In this manner, a removing device that is not shown can easily remove the tubular element from the spindle to transfer the tubular element to the container supported by the supporting element of the corresponding operating unit 3.

The containers around which the tubular elements have been arranged that are the precursors of the labels are transferred from the applying carousel 3 to the heat-shrinking carousel 50. The latter can be rotatable around a central axis F in a rotation axis G opposite the rotation axis B of the applying carousel 3. The central axis F of the heat-shrinking carousel 50 can be parallel to the rotation axis A of the applying carousel 3 and thus be vertical.

The heat-shrinking carousel 50 comprises a plurality of heating units 51, that can be distributed in an equally spaced manner along a peripheral zone of the heat-shrinking carousel 50.

Each heating unit 51 has the structure shown in detail in FIG. 2.

The heating unit 51 comprises supporting means 8 for supporting a container 2, which in the illustrated example is a bottle, to which the applying carousel 3 has applied a tubular element 5 that is the precursor of a label.

The heating unit 51 further comprises casing means 10, conformed for defining at least partially a closed chamber in which a container 2 with the corresponding tubular element 5 is housed. In particular, in the illustrated example, the closed chamber 11 is defined between the casing means 10 and the supporting means 8.

In a first embodiment shown in FIG. 2, the supporting means 8 comprises a supporting plate 9 on which a container 2 is received. The casing means 10 comprises a bell element 12 movable with respect to the supporting plate 9. The bell element 12 has a side wall 13, with an approximately tubular shape, and a transverse wall 14 that defines a cavity 15 having dimensions that are such as to enclose the container 2.

The cavity 15 is closed above by the transverse wall 14 and is open below. In particular, the side wall 13 comprises a lower end bound by an edge zone 16 that surrounds an opening 17 through which the container 2 can penetrate the cavity 15.

The bell element 12 can approach the supporting plate 9 moving downwards along a direction H, which may be vertical, in such a way that the edge zone 16 comes into contact with an upper abutting surface 18 of the supporting plate 9.

When the edge zone 16 is in contact with the upper abutting surface 18, the cavity 15 is closed and the closed chamber 11 is thus defined that encloses the container 2, isolating the container from the external environment. Between the supporting plate 9 and the bell element 12 seals or other sealing means can be provided that are suitable for hermetically insulating the closed chamber 11 from the external environment.

Each heating units 51 further comprises delivering means 19 to deliver steam 20 to the closed chamber 11 so as to heat the tubular element 5 to activate heat-shrinking of the plastics that constitute the tubular element 5. The steam 20 can be water vapour but can also be formed of other substances in aeriform state that are suitable for yielding heat to the tubular element 5.

The delivering means 19 may comprise one or more nozzles, distributed, for example, on the side wall 13 and positioned to direct the steam 20 to the tubular element 5.

Each heating units 51 further comprises pressure-reducing means 21 configured to reduce the pressure in the closed chamber 11.

The pressure-reducing means 21 may comprise sucking means, including, for example, a pump for the vacuum 22 that, by means of a sucking conduit 23, is connected to the casing means 10. The pump for the vacuum 22 enables the air contained inside the closed chamber 11 to be sucked, as shown by the arrows F in FIG. 2.

The sucking conduit 23 may be of flexible type, so as to enable the casing means 10 to be moved. The sucking conduit 23 can be connected to the casing means in a removable manner.

In one embodiment, the sucking conduit 23 can be connected to the supporting means 8, rather than to the casing means 10.

The vacuum pump 22, by sucking the air contained in the closed chamber 11, decreases the internal pressure of the latter below atmospheric pressure and enables condensation to be eliminated. In fact, by reducing internal pressure in the closed chamber 11, the temperature value is also lowered at which the steam changes to liquid state and generates condensate. In this manner, the vapour 20 is maintained in a thermodynamic condition that prevents the formation of condensate and ensures that possible drops of water previously generated because of the condensation evaporate. In the embodiment disclosed above, the support plates 9 are arranged in a fixed position on the heat-shrinking carousel 50, whilst the bell elements 12 are moved by suitable movement means so as to move towards, or away from, the corresponding support plates 9.

In one version of the apparatus, the bell elements 12 can be in a stationary position compared with the heat-shrinking carousel 50, whilst the support plates 9 are movable with respect to the corresponding bell elements 12 to introduce the containers 2 into the inside thereof. In a further version, both the bell elements 12 and the support plates 9 can be movable.

FIG. 3 shows a heating unit 151 according to an alternative embodiment, comprising a bell element 112 having an opening 117 facing upwards. In this embodiment, the supporting means 8 comprises, instead of the supporting plate 9, a gripping device 24 shaped for grasping an end portion, in particular a neck 32, of the container 2. The gripping device 24, may, for example, be made of two parts that clamp the neck 32 of the container 2 as a gripper.

The gripping device 24 comprises a flange portion 25 that extends transversely to a main axis J of the bell element 112. The flange portion 25 comprises a lower abutment surface 26 against which an edge zone 116 of the bell element 112 comes to abut, the edge zone 116 surrounding the opening 117. A closed chamber ill is thus defined, similarly to what has been disclosed for the first embodiment of FIG. 2.

The bell element 112 of FIG. 3 is movable along the direction H whilst the gripping device 24 can be in a stationary position with respect to the heat-shrinking carousel 50.

In one embodiment, the bell element 112 is in a stationary position with respect to the heat-shrinking carousel 50, whilst the gripping device 24 is movable along the direction H.

Alternatively, both the bell element 112 and the gripping device 24 can be movable.

Also the heating unit 151 comprises delivering means to deliver steam inside the closed chamber 111, for the reasons already disclosed with reference to FIG. 2. Further, similarly to what has been disclosed for the embodiment in FIG. 2, also the heating unit 151 comprises pressure-reducing means 21.

FIG. 4 shows a heating unit 251 according to a third alternative embodiment. The embodiment shown in FIG. 4 differs from that in FIG. 2 because the casing means 10 comprises a plurality of mutually movable shell elements 27. In the embodiment shown, two shell elements 27 are provided, each of which is movable along a direction M parallel to a plane defined by the supporting plate 9.

Each shell element 27 comprises a longitudinal wall 28 and an end wall 29. The two shell elements 27, during operation, move towards one another until they come into contact with one another and cooperate with the upper abutting surface 18 of the supporting plate 9 to define the closed chamber inside which the container 2 is enclosed with the respective tubular element 5 to be heat-treated.

Also in this embodiment the delivering means is provided to deliver steam to the closed chamber and the pressure-reducing means 21 to reduce the air pressure in the closed chamber.

In a version of the apparatus, it is possible to provide a number of shell elements other than two that, in a closed position, defines the bell element.

In one embodiment that is not shown, the container 2 can be retained at the neck by a gripping device similar to the gripping device 24 shown in FIG. 3, cooperating with shell elements of the type shown in FIG. 4 to define the closed chamber.

In one embodiment of the apparatus 1 that is not shown, the casing means 10 can be mounted on the applying carousel 3, which will have an appropriate diameter. In this case, it is not necessary to adopt a separate heat-shrinking carousel 50.

In all the embodiments disclosed above, the casing means 10 have dimensions such as to receive a single container 2 at a time. It is nevertheless possible to design also casing means that is able to house a group of two or more containers at a time.

In one embodiment the tubular elements 5 can be obtained according to a different method from the one disclosed above. For example, the tubular elements 5 can be obtained by cutting transversely, to the desired lengths, a reel of film that has already been welded in the shape of a pipe. During operation, the inlet wheel 30 delivers to the applying carousel 3 a plurality of containers 2 arranged in sequence. Each container 2, supported by a supporting element of the applying carousel 3, receives a respective tubular element 5 that has just been obtained on a spindle. The container 2 and the tubular element 5 associated therewith are then transferred to a heating unit of the heat-shrinking carousel 50. In particular, the container 2 can be rested on the supporting plate 9 or retained by the gripping device 24. The bell element 12 or 112 or the shell elements 27 then enclose the container in the closed chamber, into which the steam 20 is injected for heat-shrinking the tubular element 5. The pump for the vacuum 22 is then activated to suck air from the closed chamber, so as to reduce the pressure inside the chamber so that possible condensation that has previously formed can evaporate.

After the tubular element 5 has been heat-shrunk and has generated the corresponding “shrink sleeve” label adhering to the surface of the container 2, the bell element 12 or 112 or the shell elements 27 are moved so as to enable the labelled container 2 to be moved away from the applying carousel 3 by means of the outlet wheel 31. The container 2 that has just been labelled is substantially dry and devoid of condensate and can thus also be housed in cardboard boxes without causing damage.

In one embodiment, containers 2 to which the labels have to be applied, rather than being processed on carousels, can be processed on linear conveyors along which the containers 2 interact with the casing means.

1-27. (canceled)

28. Apparatus for applying a “shrink sleeve” label to a container, comprising a supporting element for supporting said container and a casing member cooperating with said supporting element for enclosing said container in a closed chamber which is hermetically insulated from the external environment so as to isolate said container from the external environment, a heating device for heating a heat-shrinkable element that is the precursor of said “shrink sleeve” label arranged around said container so as to heat-shrink said heat-shrinkable element, and a pressure-reducing member to reduce the pressure in said closed chamber so as to prevent formation of condensate.

29. Apparatus according to claim 28, wherein said heating device comprises a delivering device for delivering steam to said closed chamber.

30. Apparatus according to claim 28, wherein said pressure-reducing member is configured in such a way as to reduce the pressure in said closed chamber below atmospheric pressure.

31. Apparatus according to claim 29, wherein said pressure-reducing member is configured in such a way as to reduce the pressure in said closed chamber below atmospheric pressure.

32. Apparatus according claim 28, wherein said pressure-reducing member comprises a suction device for withdrawing air from said closed chamber.

33. Apparatus according claim 29, wherein said pressure-reducing member comprises a suction device for withdrawing air from said closed chamber.

34. Apparatus according to claim 33, wherein said suction device comprises a pump for the vacuum in communication with said closed chamber.

35. Apparatus according to claim 34, wherein said suction device comprises a suction conduit for connecting said pump for the vacuum to said closed chamber.

36. Apparatus according to claim 28, and further comprising a supporting element for supporting said container in said closed chamber, said closed chamber being defined between said supporting element and said casing member, further comprising a movement device for mutually moving said casing member and said supporting element so as to define said closed chamber.

37. Apparatus according to claim 36, wherein said supporting element comprises a supporting surface on which said container rests, said supporting surface being obtained on a supporting plate.

38. Apparatus according to claim 36, wherein said supporting element comprises a gripping device suitable for grasping a portion of said container, said gripping device being configured so as to grasp a neck of said container, said gripping device comprising a flange portion suitable for being operationally arranged around said portion for abuttingly engaging with said casing member.

39. Apparatus according to claim 28, wherein said casing member comprises a bell element which is movable parallel to an axis of said container to move away from or towards said supporting element so as to define said closed chamber.

40. Apparatus according to claim 28, wherein said casing member comprises at least two shell elements that are mutually movable in a direction that is transverse to an axis of said container to define said closed chamber.

41. Apparatus according to claim 28, wherein said casing member defines a closed chamber of dimensions such as to house a single container.

42. Apparatus according claim 28, wherein said casing member is included in a work unit, said apparatus comprising a plurality of work units arranged in a peripheral region of a heat-shrinking carousel.

43. Apparatus according to claim 42, and further comprising an applying carousel arranged upstream of said heat-shrinking carousel and having a plurality of operating units for applying said heat-shrinkable element that is a precursor of said “shrink sleeve” label to said container.

44. Apparatus according to claim 43, wherein said work units comprise an arrangement for applying said heat-shrinkable element precursor of said “shrink sleeve” label to said container.

45. A method for labelling a container with a “shrink sleeve” label, comprising enclosing said container in a closed chamber which is hermetically insulated from the external environment so as to isolate said container from the external environment, heating a heat-shrinkable element precursor of said “shrink sleeve” label arranged around said container so as to heat-shrink said heat-shrinkable element, and reducing pressure in said closed chamber so as to prevent formation of condensate.

46. A method according to claim 45, wherein said heat-shrinkable element is heated by injecting steam in said closed chamber.

47. A method according to claim 45, wherein the pressure in said closed chamber is reduced below atmospheric pressure.

48. A method according to claim 46, wherein the pressure in said closed chamber is reduced below atmospheric pressure.

49. A method according to claim 48, wherein the pressure is reduced by withdrawing air from said closed chamber.

50. A method according to claim 45, wherein said closed chamber is defined by a moving casing member and a supporting element supporting said container towards one another.

51. A method according to claim 50, wherein said casing member and said supporting element are brought into mutual contact to define said closed chamber.
